(19) United States
(12) Patent Application Publication
(10) Pub. No.: US 2015/0075333 A1
(43) Pub. Date: Mar. 19, 2015

(54) WRENCH TOOL FOR SCREWDRIVER BITS

(71) Applicant: Wei-Lin Chen, Taichung (TW)

(72) Inventor: Wei-Lin Chen, Taichung (TW)

(21) Appl. No.: 14/031,045

(22) Filed: Sep. 19, 2013

(51) Int. Cl. B25B 23/00; B25B 13/46

(52) U.S. Cl. CPC B25B 23/0035; B25B 13/463
USPC 81/61; 81/439

(57) ABSTRACT

A wrench tool for screwdriver bits contains a body, a biasing member, and an elastic element. The body includes a tool seat received in an end portion thereof, the tool seat includes a fitting groove defined on a first end thereof and fitting with screwdriver bits, the fitting groove has a locking structure for retaining the screwdriver bits, and the tool seat further includes a second end communicating with the fitting groove. The biasing member is secured on the second end of the tool seat, the biasing member has a pushing portion fixed on a first end thereof and extending out of the fitting groove and has a pressing portion disposed on a second end thereof and pressed to push the screwdriver bits. The elastic element is mounted on the second end of the tool seat and used to push the biasing member to move back to an original position.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

1. Field of Invention

The present invention relates to a wrench tool which forces a screwdriver bit to extend a long distance out of a fitting groove of a tool seat by ways of a biasing member so that the screwdriver bit is removed easily.

2. Description of Related Arts

Referring to FIGS. 1 and 2, a conventional wrench tool contains a body 10, and the body 10 includes a tool seat 11 disposed on one end thereof and having a polygonal fitting groove 111, the fitting groove 111 has a peripheral slot 112 defined therein for receiving a retainer 12. When a screwdriver bit 20 with a locking notch 201 is fitted with the fitting groove 111 of the tool seat 11, the retainer 12 retains with the locking notch 201 of the screwdriver bit 20, thus positioning the screwdriver bit 20. However, as desiring to replace a different type of screwdriver bit, a pulling force is forced on the screwdriver 20 by a user and is larger than a retaining force of the retainer 12 so that the retainer 12 disengages from the locking notch 201 of the screwdriver bit 20, and then the screwdriver bit 20 is removed from the fitting groove 111 of the tool seat 11. But most part of the screwdriver bit 20 is inserted into the fitting groove 111, so only the rest part of the screwdriver bit 20 extends out of the fitting groove 111 of the tool seat 11, thus removing the screwdriver bit 20 difficulty.

The present invention has arisen to mitigate and/or obviate the afore-described disadvantages.

### SUMMARY OF THE PRESENT INVENTION

The primary object of the present invention is to provide a wrench tool which forces a screwdriver bit to extend a long distance out of a fitting groove of a tool seat by ways of a biasing member so that the screwdriver is removed easily.

Another object of the present invention is to provide a wrench tool which after removing the screwdriver bit, a pressing portion of the biasing member is released so that an elastic element pushes the biasing member to move back to the original position, thus fitting another screwdriver bit with the fitting groove of the tool seat easily.

To obtain the above objectives, a wrench tool for screwdriver bits provided by the present invention contains: a body, a biasing member, and an elastic element.

The body includes a tool seat received in an end portion thereof, the tool seat includes a fitting groove defined on a first end thereof and fitting with screwdriver bits, the fitting groove has a locking structure for retaining the screwdriver bits, and the tool seat further includes a second end communicating with the fitting groove.

The biasing member is secured on the second end of the tool seat, the biasing member has a pushing portion fixed on a first end thereof and extending out of the fitting groove and has a pressing portion disposed on a second end thereof and pressed to push the screwdriver bits.

The elastic element is mounted on the second end of the tool seat and used to push the biasing member to move back to an original position.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a cross sectional view showing the operation of a conventional wrench tool.

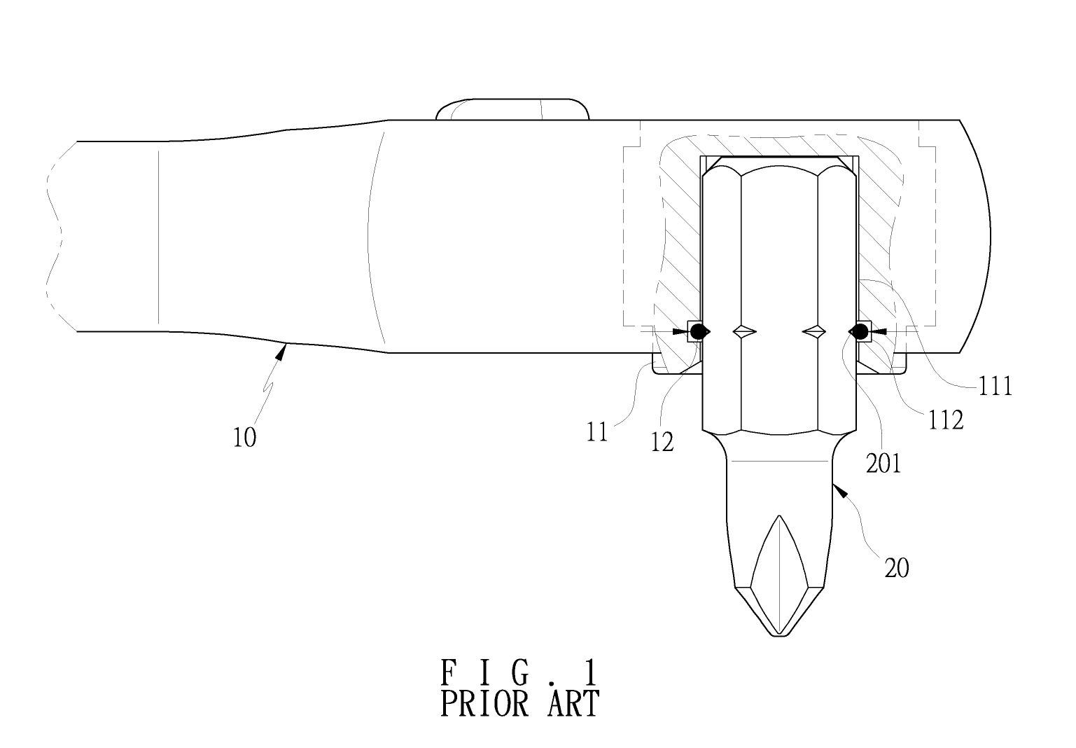

FIG. 2 is another cross sectional view showing the operation of the conventional wrench tool.

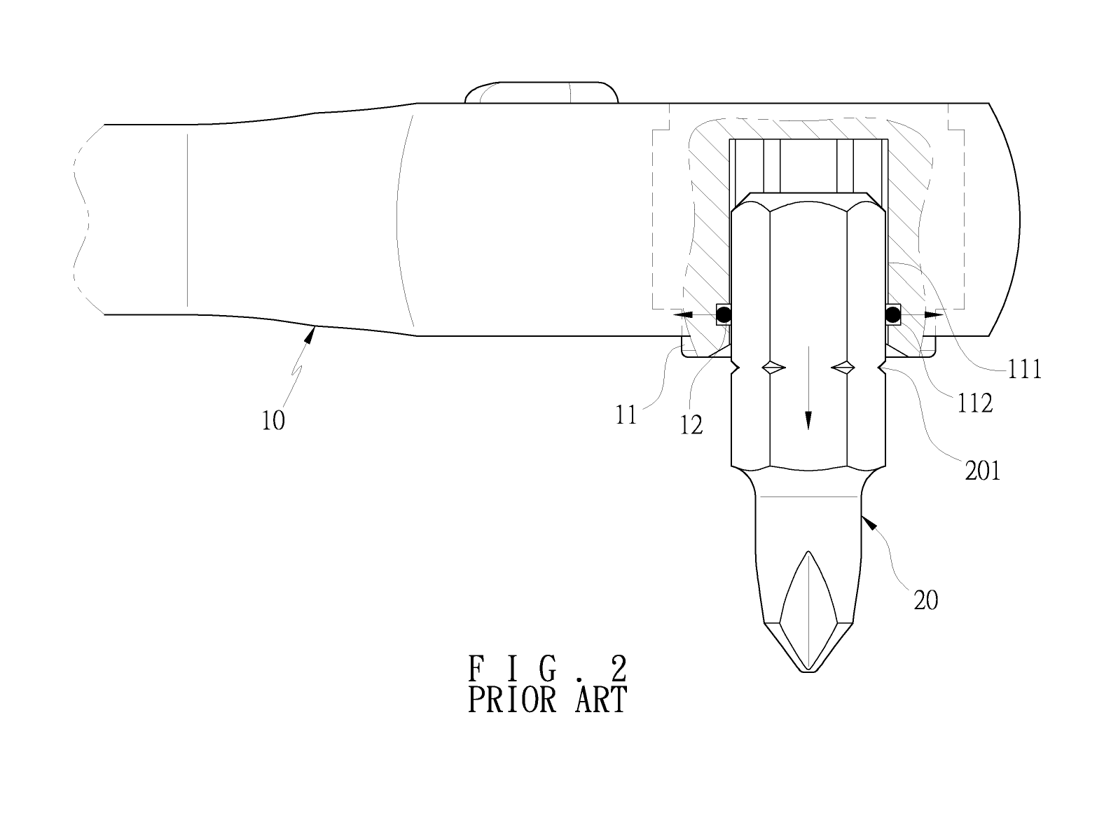

FIG. 3 is a perspective view showing the exploded components of a wrench tool for screwdriver bits according to a preferred embodiment of the present invention.

FIG. 4 is a perspective view showing the assembly of the wrench tool for the screwdriver bits according to the preferred embodiment of the present invention.

FIG. 5 is a cross sectional view showing the assembly of the wrench tool for the screwdriver bits according to the preferred embodiment of the present invention.

FIG. 6 is a cross sectional view showing the operation of the wrench tool for the screwdriver bits according to the preferred embodiment of the present invention.

FIG. 7 is another cross sectional view showing the operation of the wrench tool for the screwdriver bits according to the preferred embodiment of the present invention.

FIG. 8 is also another cross sectional view showing the operation of the wrench tool for the screwdriver bits according to the preferred embodiment of the present invention.

FIG. 9 is still another cross sectional view showing the operation of the wrench tool for the screwdriver bits according to the preferred embodiment of the present invention.

### DETAILED DESCRIPTION OF THE PREFERRED EMBODIMENT

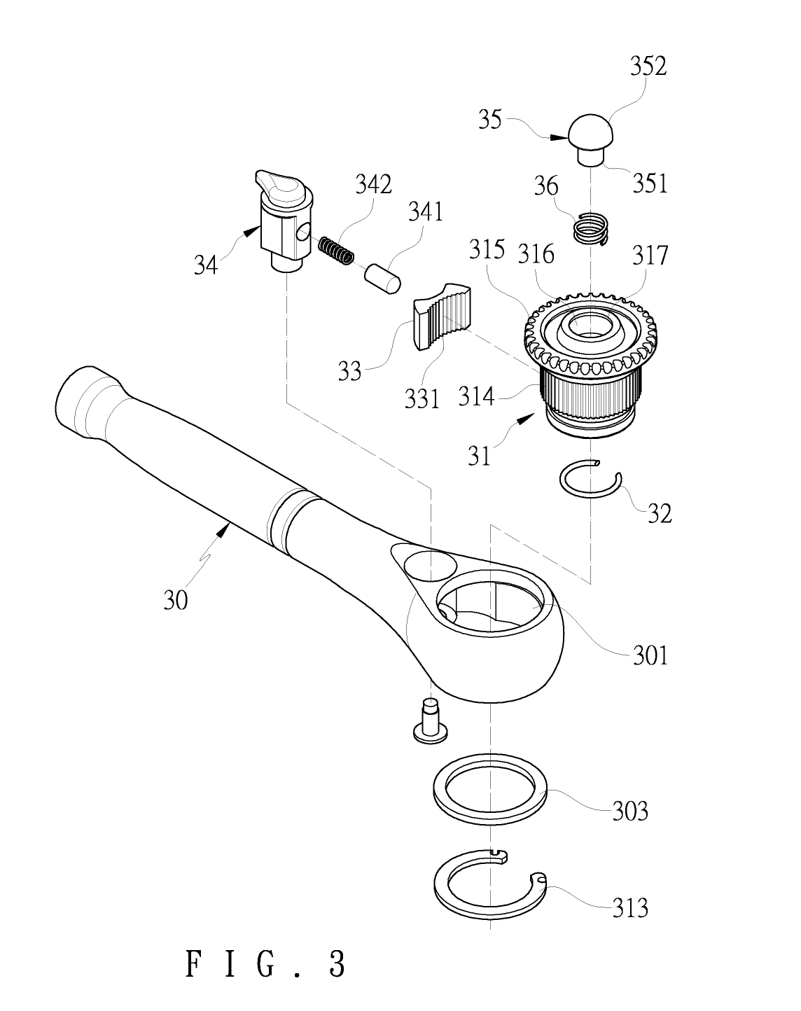

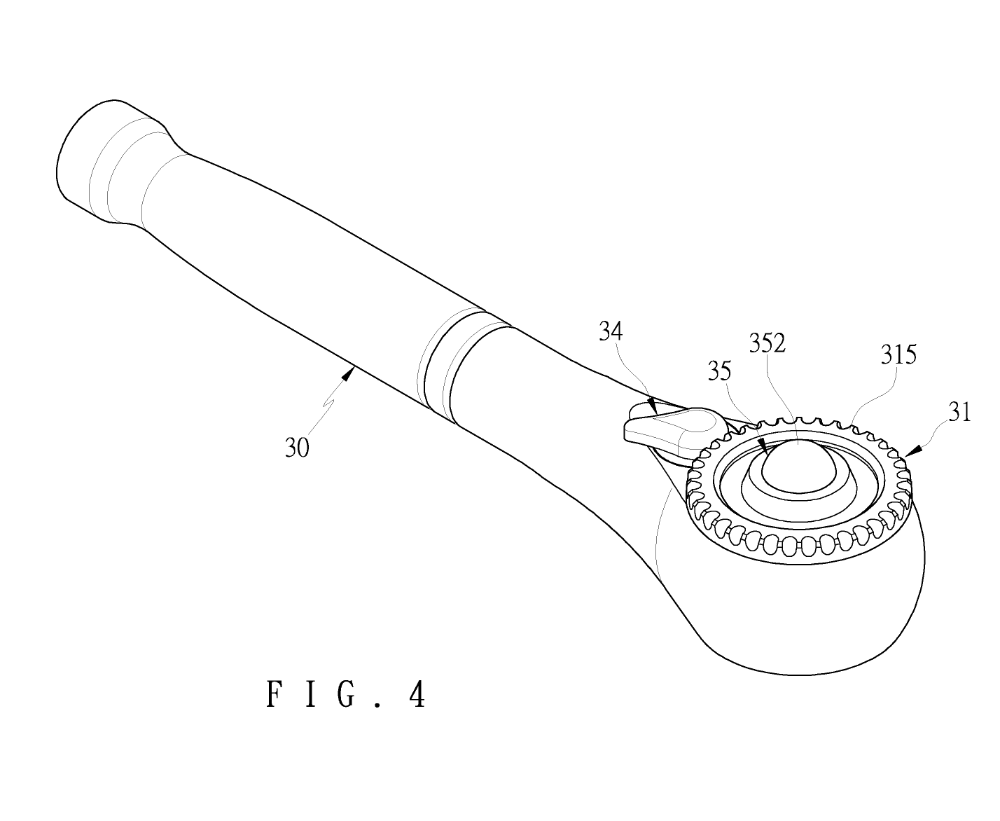

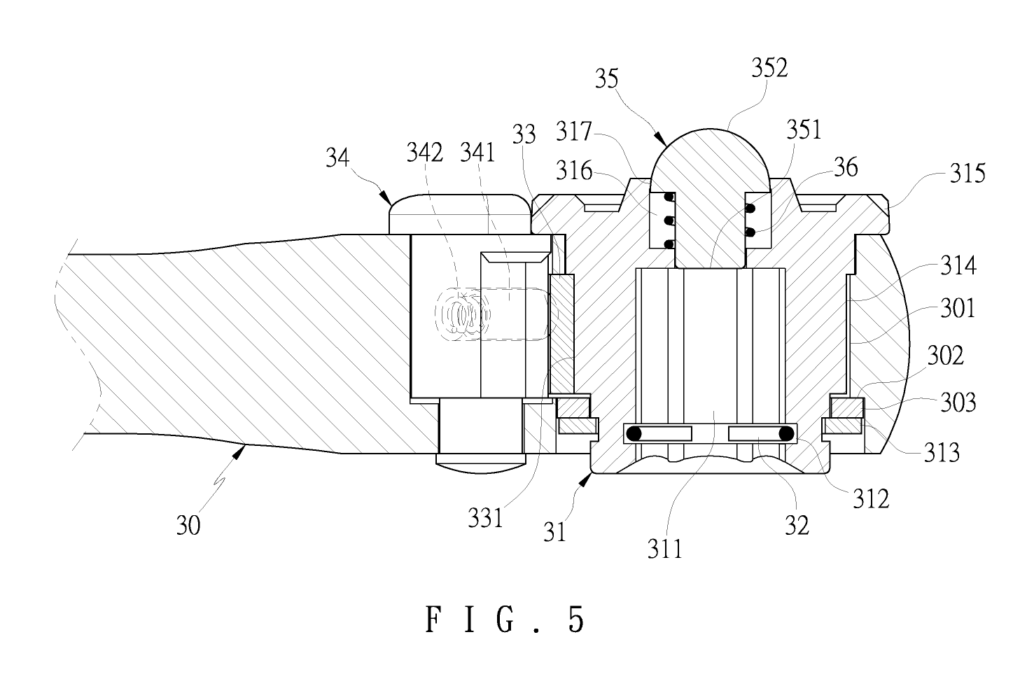

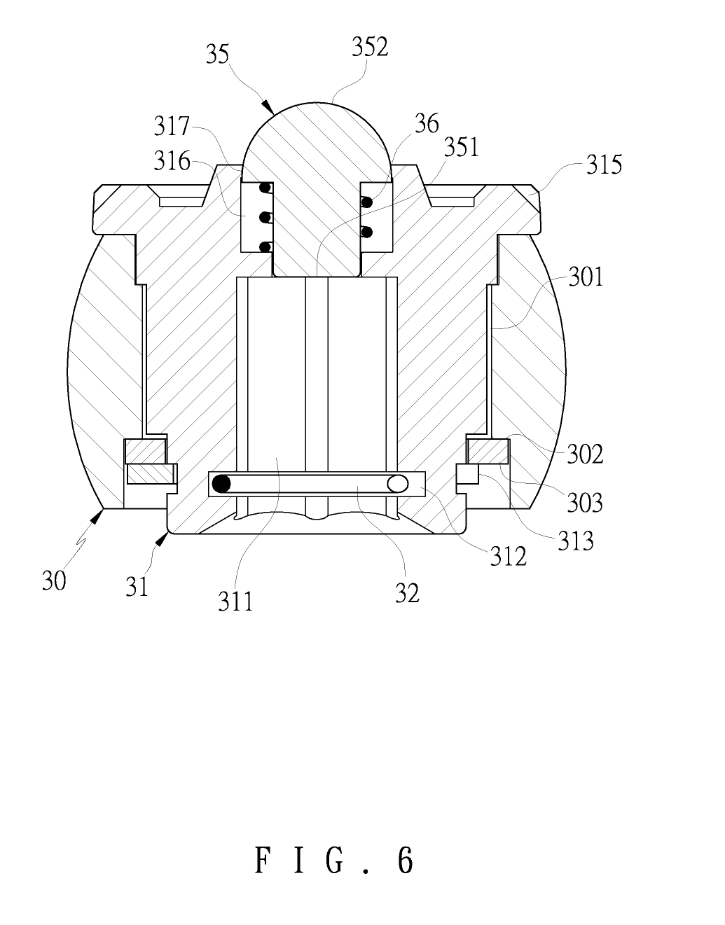

With reference to FIGS. 3 to 6, a wrench tool for screwdriver bits according to a preferred embodiment of the present invention comprises a body 30, the body 30 includes a receiving portion 301 defined on an end portion thereof so as to receive a tool seat 31, and between the receiving portion 301 of the body 30 and the tool seat 31 is defined a connecting structure. In this embodiment, the connecting structure includes a stepped face 302 formed on the receiving portion 301 of the body 30, a locking ring 313 fixed around the tool seat 31, and a stopping loop 303 mounted between the locking ring 313 of the tool seat 31 and the stepped face 302 of the body 30, such that the locking ring 313 of the tool seat 31 is limited by the stopping loop 303, the tool seat 31 is fixed and rotated in the receiving portion 301 of the body 30. Also, between the tool seat 31 and the body 30 is defined a ratchet device, and the ratchet device includes plural peripheral teeth 314 arranged around an outer peripheral wall of the tool seat 31, a locking block 33 disposed on an inner peripheral wall of the receiving portion 301 of the body 30, a toothed portion 331 arranged on one end of an outer wall of the locking block 33 so as to engage with the plural peripheral teeth 314 of the tool seat 31, and a shifting member 34 disposed on the body 30, wherein the shifting member 34 has an abutting element 341 fixed thereon and a resilient spring 342 for pushing the abutting element 341, such that the abutting element 341 is biased against the locking block 33, and the toothed portion 331 of the locking block 33 engages with the plural peripheral teeth 314 of the tool seat 31, so after the shifting member 34 is switched, the toothed portion 331 of the locking block 33 engages with or disengages from the plural peripheral teeth 314 of the tool seat 31, thus rotating the body 30. Preferably, the tool seat 31 includes a rotating disc 315 mounted on a top end thereof and extending out of the receiving portion 301 of the body 30 so as to rotate the tool seat 31; the tool seat 31 also includes a polygonal fitting groove 311 defined on a first end thereof and used to fit with screwdriver bits, each having a varying type. The fitting groove 311 has a locking structure fixed therein so as to retain the screwdriver bits, and the locking structure includes a peripheral trench 312 defined in the fitting groove 311 so as to receive a C-shaped retainer 32 for retaining the screwdriver bits, such that the screwdriver bits are retained in the fitting groove 311 securely by the C-shaped retainer 32. The tool seat 31 further includes a second end communicating with the fitting groove 311, in this embodiment, the second end of the tool seat 311 has a fixing notch 316 formed therein and communicating with the fitting groove 311 and has a biasing member 35 secured thereon and inserting into the fitting groove 311. In this embodiment, the biasing member 35 is arranged in the fixing notch 316 of the second end of the tool seat 31, and the biasing member 35 has a pushing portion 351 fixed on a first end thereof and a spherical pressing portion 352 disposed on a second end thereof. The tool seat 31 also includes an elastic element 36 mounted on the second end thereof, and the elastic element 36 is a spring for pushing the biasing member 35. In this embodiment, the elastic element 36 is mounted in the fixing notch 316 of the second end of the tool seat 31 so that when the biasing member 35 is pressed, the pushing portion 351 extends out of the fitting groove 311 of the tool seat 31, thus pushing the screwdriver bits; and when the pressing portion 352 of the biasing member 35 is released, the elastic element 36 pushes the biasing member 35 to move back an original position. To prevent the biasing member 35 from disengaging from the fixing notch 316 of the tool seat 31, between the fixing notch 316 and the biasing member 35 is defined a limiting structure, and the limiting structure includes a stopping fringe 317 rivet pressed so as to limit the pressing portion 352 of the biasing member 35.

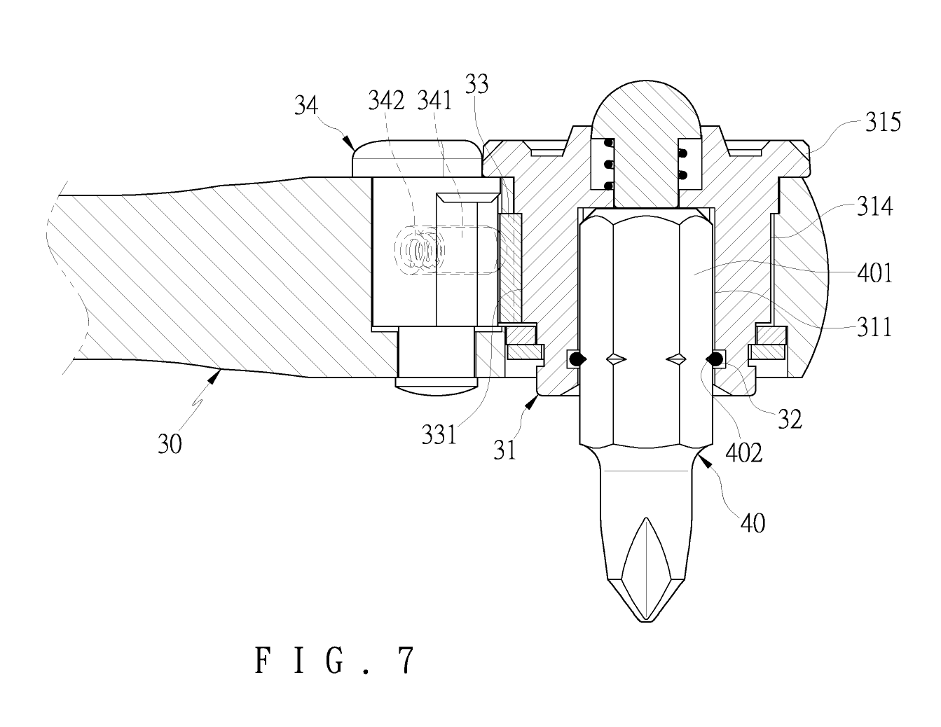

Referring further to FIG. 7, in operation, the fitting groove 311 of the tool seat 31 matches with a screwdriver bit 40, wherein the screwdriver bit 40 has a coupling portion 401 with an engaging recess 402 for fitting with the fitting groove 311 of the tool seat 31, such that the C-shaped retainer 32 in the fitting groove 311 retains with the engaging recess 402 of the screwdriver bit 40, thus positioning the screwdriver bit 40 in the fitting groove 311 of the tool seat 31 fixedly. Furthermore, the shifting member 34 of the ratchet device is used to switch an engagement and a disengagement of the toothed portion 331 of the locking block 33 and the plural peripheral teeth 314 of the tool seat 31, such that when the body 30 is rotated, it has a ratchet function; and before a bolt tool is rotated tightly or after the bolt tool is rotated loosely, the rotating disc 315 of the tool seat 31 is rotated quickly so that the screwdriver bit 40 is driven by the rotating disc 315 to fasten or unfasten the bolt tool, thus removing the bolt tool quickly.

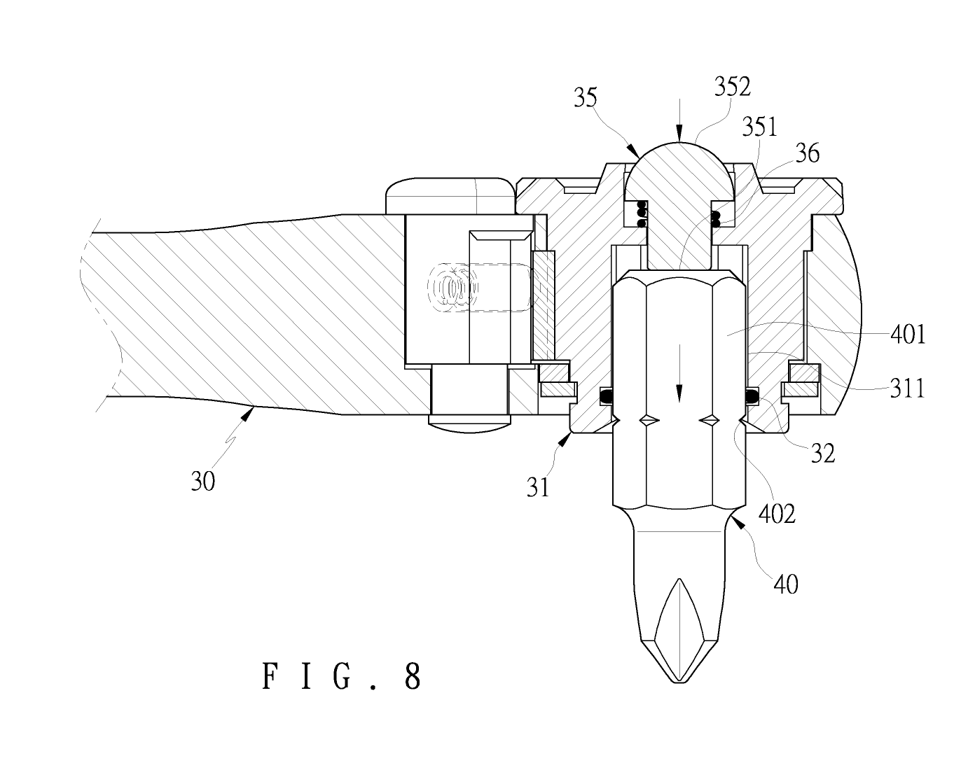

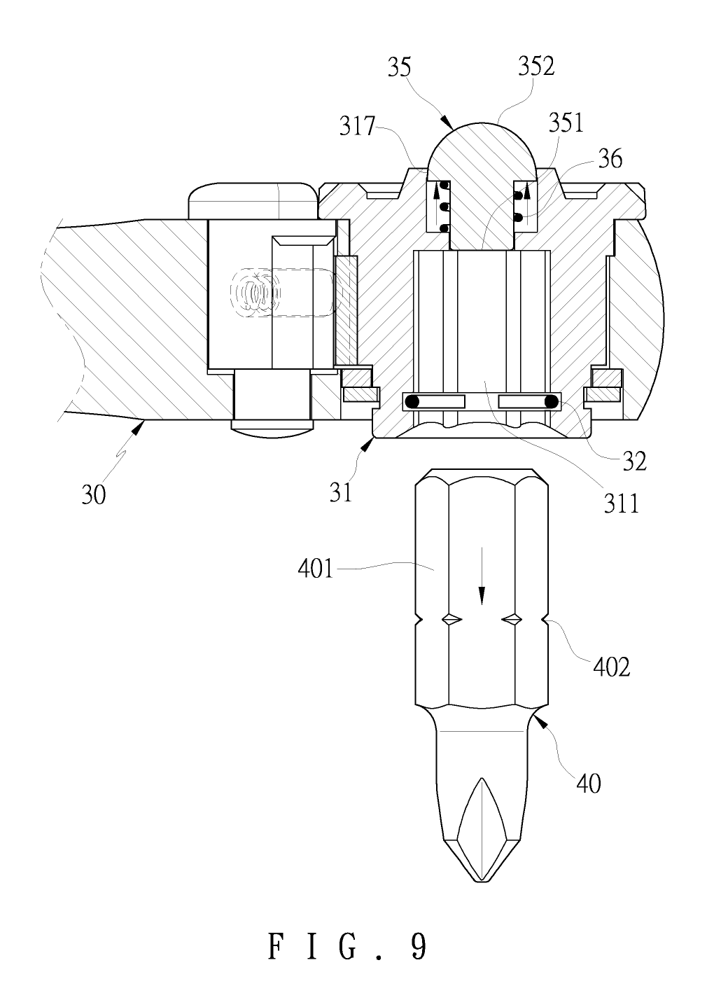

As shown in FIG. 8, when desiring to remove the screwdriver bit 40, the pressing portion 352 of the biasing member 35 is pressed so that the biasing member 35 moves in the fixing notch 316 of the tool seat 31, and the pushing portion 351 of the biasing member 35 pushes the screwdriver bit 40 outwardly, such that the engaging recess 402 of the screwdriver bit 40 disengages from the C-shaped retainer 32 in the fitting groove 311, thereby forcing the screwdriver bit 40 to extend a long distance out of the fitting groove 311 of the tool seat 31. As illustrated in FIG. 9, after the biasing member 35 pushes the screwdriver bit 40 out of the fitting groove 311, the screwdriver bit 40 is removed so as to replace another screwdriver bit easily. After removing the screwdriver bit 40, the pressing portion 352 of the biasing member 35 is released so that the elastic element 36 pushes the biasing member 35 to move back to the original position, thus fitting another screwdriver bit with the fitting groove 311 of the tool seat 31.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A wrench tool for screwdriver bits, comprising:
a body including a tool seat received in an end portion thereof, wherein said tool seat including a fitting groove which is defined on a first end thereof and used to fit with said screwdriver bits, wherein said fitting groove having a locking structure fixed therein so as to retain said screwdriver bits, wherein said tool seat further including a second end communicating with said fitting groove;
a biasing member which is secured on said second end of said tool seat of said body, wherein said biasing member having a pushing portion fixed on a first end thereof which is extending out of said fitting groove of said tool seat and a pressing portion disposed on a second end thereof which is pressed to push said screwdriver bits; and
an elastic element mounted on said second end of said tool seat of said body and used to push said biasing member to move back to an original position.

2. The wrench tool for the screwdriver bits, as recited in claim 1, wherein said locking structure of said body further includes a peripheral trench defined in said fitting groove so as to receive a retainer.

3. The wrench tool for the screwdriver bits, as recited in claim 1, wherein said second end of said tool seat of said body having a fixing notch formed therein and communicating with said fitting groove of said first end of said tool seat, wherein said fixing notch having said biasing member and said elastic element fixed therein.

4. The wrench tool for the screwdriver bits, as recited in claim 3, wherein a limiting structure is defined between said fixing notch and said biasing member, wherein said limiting structure further includes a stopping fringe rivet pressed so as to limit said pressing portion of said biasing member.

5. The wrench tool for the screwdriver bits, as recited in claim 1, wherein said body further includes a receiving portion defined on said end portion thereof so as to receive said tool seat.

6. The wrench tool for the screwdriver bits, as recited in claim 5, wherein a connecting structure is defined between said receiving portion of said body and said tool seat, wherein said connecting structure further includes a stepped face formed on said receiving portion of said body, a locking ring fixed around said tool seat and a stopping loop mounted between said locking ring of said tool seat and said stepped face of said body, such that said locking ring of said tool seat is limited by said stopping loop.

7. The wrench tool for the screwdriver bits, as recited in claim 5, wherein a ratchet device is defined between said tool seat and said body, wherein said ratchet device further includes a plural peripheral teeth which is arranged around an outer peripheral wall of said tool seat, a locking block disposed on an inner peripheral wall of said receiving portion of said body, a toothed portion which is arranged on one end of an outer wall of said locking block to engage with said plural peripheral teeth of said tool seat and a shifting member disposed on said body, wherein said shifting member having an abutting element fixed thereon and a resilient spring for pushing said abutting element, such that said abutting element is biased against said locking block, wherein said toothed portion of said locking block engages with said plural peripheral teeth of said tool seat.

8. The wrench tool for the screwdriver bits, as recited in claim 5, wherein said tool seat of said body further includes a rotating disc mounted on a top end thereof and extending out of said receiving portion of said body so as to rotate said tool seat.

9. The wrench tool for the screwdriver bits, as recited in claim 1, wherein said pressing portion is spherical.

10. The wrench tool for the screwdriver bits, as recited in claim 1, wherein said elastic element is a spring.
